(19) United States
(12) Patent Application Publication
(10) Pub. No.: US 2010/0321731 A1
(43) Pub. Date: Dec. 23, 2010

(54) IMAGE PROCESSING APPARATUS AND METHOD OF CONTROLLING THE IMAGE PROCESSING APPARATUS

(75) Inventor: Kazumasa Yasui, Tokyo (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/816,279

(22) Filed: Jun. 15, 2010

Related U.S. Application Data
(60) Provisional application No. 61/218,843, filed on Jun. 19, 2009.

(51) Int. Cl. G06F 3/12; G06K 15/00; H04N 1/04

(52) U.S. Cl. 358/1.15; 358/1.16; 358/474

(57) ABSTRACT

According to one embodiment, an image processing apparatus includes a document table, a document feeder, an opening sensor, an image reading unit, an operation unit, a first memory, a second memory, and a control unit. An original is placed on the document table. The document feeder can open and close an upper part of the document table and conveys the original. The opening sensor detects whether the document feeder opens the document table. The operation unit receives the input of information indicating processing content for the image data. The first memory stores first configuration. The second memory stores second configuration corresponding to the information input to the operation unit. The control unit changes, if the opening sensor detects the opening of the document table, the second configuration stored in the second memory to the first configuration.

### CROSS-REFERENCE TO RELATED APPLICATIONS

This application is based upon and claims the benefit of priority from U.S. Provisional Application No. 61/218,843 filed on Jun. 19, 2009; the entire contents of which are incorporated herein by reference.

### FIELD

Embodiments described herein relate generally to an image processing apparatus and a method of controlling the image processing apparatus.

### BACKGROUND

An image processing apparatus such as a digital multi-functional peripheral often adopts an operation form in which the image processing apparatus is shared by a large number of users. In the digital multi-functional peripheral shared by plural users, in some case, setting content of a user who just finishes using the digital multi-functional peripheral remains. If setting performed by the preceding user remains, a user who uses the digital multi-functional peripheral next needs to operate an operation panel and clear the setting performed by the preceding user. In the digital multi-functional peripheral shared by plural users, even if default setting is acceptable, in some case, operation for clearing the setting performed by the preceding user is necessary before processing is started.

### BRIEF DESCRIPTION OF THE DRAWINGS

FIG. 1 is an external view of a configuration example of a digital multi-functional peripheral;

FIG. 2 is a sectional view of the configuration example of the digital multi-functional peripheral;

FIG. 3 is a diagram of a configuration example of a control panel;

FIG. 4 is a block diagram for explaining a configuration example of a control system in the digital multi-functional peripheral; and

FIG. 5 is a flowchart for explaining auto-clear of setting content.

### DETAILED DESCRIPTION

In general, according to one embodiment, an image processing apparatus includes a document table, a document feeder, an opening sensor, an image reading unit, an operation unit, a first memory, a second memory, and a control unit. An original is placed on the document table. The document feeder is capable of opening and closing an upper part of the document table and conveys the original. The opening sensor detects whether the document feeder opens the document table. The image reading unit generates image data of a first original conveyed by the document feeder or a second original placed on the document table. The operation unit receives the input of information indicating processing content for the image data. The first memory stores a first configuration. The second memory stores a second configuration corresponding to the information input to the operation unit. The control unit changes, if the opening sensor detects the opening of the document table, the second configuration stored by the second memory to the first configuration.

An embodiment is explained in detail below.

First, the configuration of a digital multi-functional peripheral (MFP) as the image processing apparatus is explained.

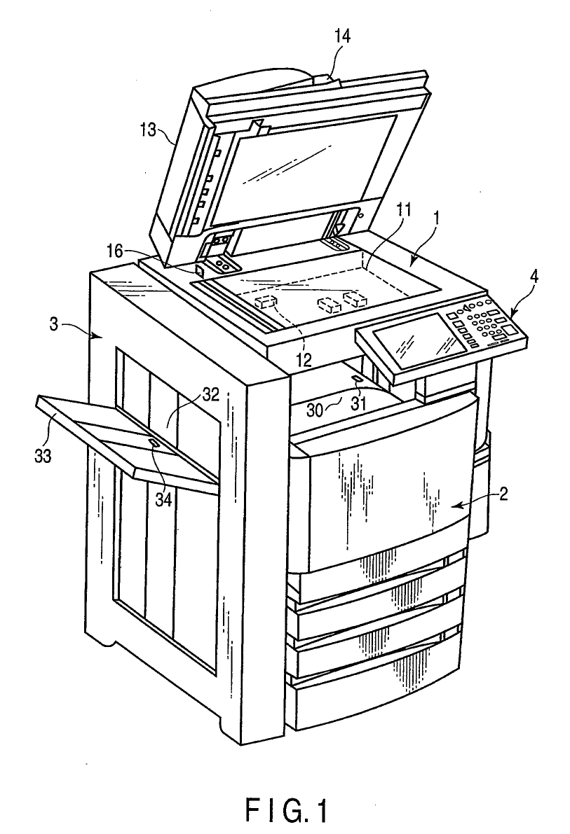

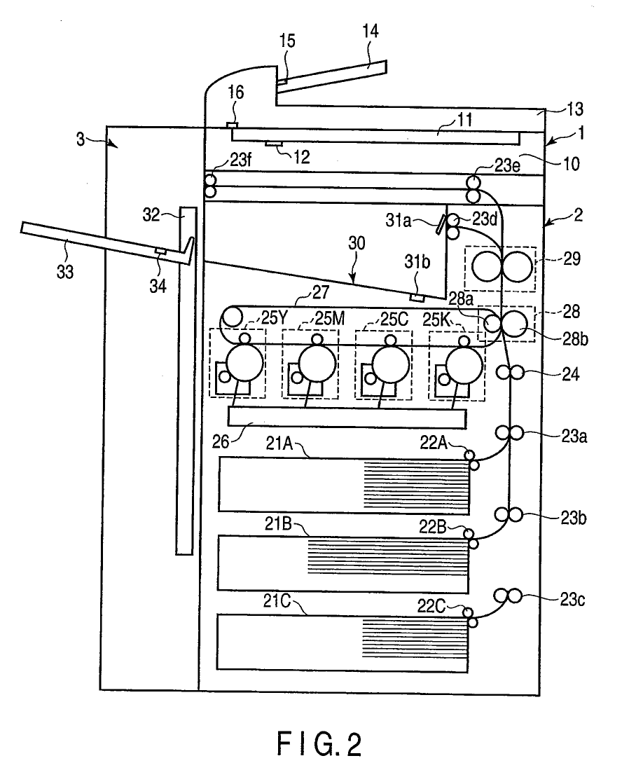

FIG. 1 is a perspective view of an external configuration example of the digital multi-functional peripheral. FIG. 2 is a schematic sectional view of an internal configuration example of the digital multi-functional peripheral. As shown in FIG. 1, the digital multi-functional peripheral includes a scanner 1, a printer 2, a finisher 3, and a control panel 4.

The scanner 1 is set in an upper part of a main body of the digital multi-functional peripheral. The scanner 1 is an apparatus configured to optically read an image of an original. The scanner 1 includes an image reading unit 10 as a photoelectric conversion unit including a CCD line sensor configured to convert an image for one line in a main scanning direction in the original into image data. The image reading unit 10 reads an image of the entire original by scanning the original with the CCD line sensor in a sub-scanning direction of the original.

The scanner 1 includes a original glass 11 and a original detection sensor 12. An original to be scanned by the image reading unit 10 is placed on the original glass 11. The image reading unit 10 scans the original on the original glass 11 via glass of the original glass 11. The original detection sensor 12 detects the original on the original glass 11. The original detection sensor 12 outputs a signal indicating presence or absence of the original on the original glass 11. The original detection sensor 12 detects a document size of the original on the original glass 11.

The scanner 1 includes an auto document feeder (ADF) 13. The ADF 13 includes a sheet feeding tray 14 and a original tray sensor 15. The sheet feeding tray 14 stores originals to be read. The original tray sensor 15 detects whether the originals are present on the sheet feeding tray 14. The ADF 13 conveys the originals, which are stored by the sheet feeding tray 14, one by one. The scanner 1 reads an image of the original conveyed by the ADF 13.

In the scanner 1, the ADF 13 also functions as a cover for an original placed on the original glass 11. The ADF 13 is attached on the original glass 11 in the main body of the digital multi-functional peripheral in a state in which the entire ADF 13 is openable and closable. The scanner 1 includes an platen sensor 16 configured to detect open and closed states of the ADF 13. If a user sets an original on the original glass 11, since the ADF 13 as the document cover is opened, the platen sensor 16 outputs a signal indicating the open state.

The printer 2 includes sheet feeding cassettes 21A, 21B, and 21C. The sheet feeding cassettes 21A, 21B, and 21C store sheets as image formation media on which images are printed. For example, the sheet feeding cassettes 21A, 21B, and 21C are detachably attachable to a lower part of the main body of the digital multi-functional peripheral. The sheet feeding cassettes 21A, 21B, and 21C respectively include sheet feeding rollers 22A, 22B, and 22C. The sheet feeding rollers 22A, 22B, and 22C extract the sheets from the sheet feeding cassettes 21A, 21B, and 21C one by one.

A conveying unit 23 conveys a sheet in the printer 2. The conveying unit 23 includes plural conveying rollers 23a to 23f and a registration roller 24. The conveying unit 23 conveys the sheet extracted by the sheet feeding rollers 22A, 22B, and 22C to the registration roller 24. The registration roller 24 conveys the sheet to a transfer position at timing for transferring an image.

Plural image forming units 25 (25Y, 25M, 25C, and 25K) respectively form images of colors (yellow, magenta, cyan, and black). An exposing unit 26 forms, on image bearing members in the image forming units 25 (25Y, 25M, 25C, and 25K), electrostatic latent images as images to be developed in the respective colors. An intermediate transfer belt 27 is an intermediate transfer member. The image forming units 25 (25Y, 25M, 25C, and 25K) form toner images on the intermediate transfer belt 27 by respectively developing the electrostatic latent images with toners of the colors (yellow, magenta, cyan, and black).

The image forming units 25Y, 25M, 25C, and 25K transfer (primarily transfer) the toner images developed with the toners of the colors (yellow, magenta, cyan, and black) onto the intermediate transfer belt 27 while superimposing the toner images one on top of another. The intermediate transfer belt 27 holds a color image in which the toner images of the respective colors overlap one another. A transfer unit 28 transfers the color image formed with the toners of the plural colors on the intermediate transfer belt 27 onto a sheet in a secondary transfer position. The secondary transfer position is a position where the toner images on the intermediate transfer belt 27 are transferred onto the sheet. The secondary transfer position is a position where a supporting roller 28a and a secondary transfer roller 28b are opposed to each other. The registration roller 24 conveys the sheet to the secondary transfer position to be timed to coincide with the toner images on the intermediate transfer belt 27.

The transfer unit 28 feeds the sheet having the toner images transferred thereon to a fuser 29. The fuser 29 fixes the toner images on the sheet. The fuser 29 heats, in a pressed state, the sheet having the toner image transferred thereon by the transfer unit 28. The fuser 29 conveys the sheet subjected to fixing processing to a exit tray 30 or the finisher 3. The exit tray 30 includes a sheet exit sensor 31a and a sheet sensor 31b. The sheet exit sensor 31a detects the output of the sheet to the exit tray 30. The sheet sensor 31b detects whether the sheet is present on the exit tray 30.

The printer 2 shown in FIG. 2 is a printer of an electrophotographic system. However, the printer in this embodiment is not limited to the electrophotographic system. This embodiment can also be applied to a printer of a system other than the electrophotographic system such as an ink-jet system or a thermal transfer system.

The finisher 3 includes a sheet discharge mechanism 32 configured to process a sheet having an image formed thereon by the printer 2. The finisher 3 includes a exit tray 33 on which the sheet having the image formed thereon by the printer 2 is accumulated. For example, the sheet discharge mechanism 32 moves the exit tray 33 every time the printer 2 discharges sheets in one copy unit. The finisher 3 includes a sheet exit sensor 34. The sheet exit sensor 34 detects whether a sheet is placed on the exit tray 33. The finisher 3 may be a finisher having a function for stapling or a function for punching sheets accumulated on the exit tray 33.

The control panel 4 is a user interface. The control panel 4 displays guidance and receives an input of an operation button or an icon. For example, the user inputs setting information in the control panel 4.

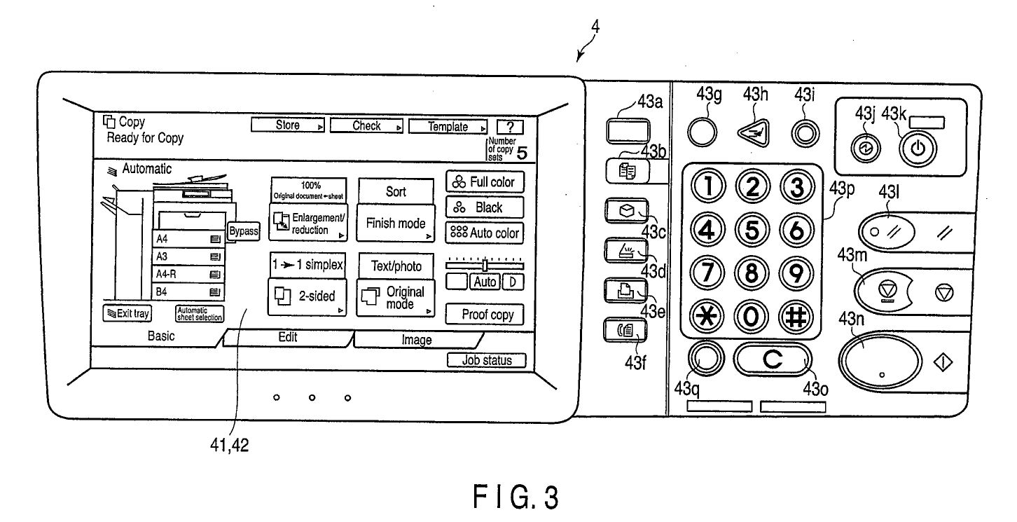

FIG. 3 is a diagram of a configuration example of the control panel 4. In the example shown in FIG. 3, the control panel 4 includes a display device 41, a touch panel 42, and plural operation buttons 43 (43a to 43p). The display device 41 displays guidance. The display device 41 has the touch panel 42 on a display screen. The touch panel 42 detects a section touched by the user on the display screen of the display device 41. The user can select, with the touch panel 42, an icon to be displayed by the display device 41.

The plural operation buttons 43 include a menu button 43a, operation mode selection buttons (a copy button 43b, a filing box button 43c, a scan button 43d, a print button 43e, and a FAX button 43f), a set/register button (a setting button) 43g, an interrupt button 43h, a counter button 43i, a power saving button 43j, a power button 43k, a reset button 43l, a stop button 43m, a start button 43n, a clear button 43o, a ten key 43p, and a setting hold button 43q.

The menu button 43a is a button for instructing display of a menu screen. If the menu button 43a is pressed, the display device 41 displays a template often used by the user. The copy button 43b is a button for instructing a copy mode as an operation mode. The filing box button 43c is a button for instructing extraction of stored image data. The scan button 43d is a button for instructing a scan mode as the operation mode. The print button 43e is a button for instructing, for private printing or the like, a print mode as the operation mode. The FAX button 43f is a button for instructing a facsimile mode as the operation mode.

For example, if the user uses the copy mode, the user presses the copy button 43b. If the user presses the copy button 43b, the digital multi-functional peripheral enters the copy mode. If the digital multi-functional peripheral is in the copy mode, the display device 41 displays a copy setting screen. Immediately after the user presses the copy button 43b, the display device 41 displays the copy setting screen on which default setting in the copy mode is reflected. In a state in which the copy setting screen is displayed, the user can change setting content to desired setting content. For example, the user can change the number of copies by pressing the ten key 43p. If the user presses the start button 43n, the digital multi-functional peripheral executes copying with the setting content displayed on the display device 41.

If the user uses the scan mode, the user presses the scan button 43d. If the user presses the scan button 43d, the digital multi-functional peripheral enters the scan mode. If the digital multi-functional peripheral is in the scan mode, the display device 41 displays a scan setting screen. Immediately after the user presses the scan button 43d, the display device 41 displays the scan setting screen on which default setting in the scan mode is reflected. Setting content can be changed in a state in which the scan setting screen is displayed. If the user presses the start button 43n, the digital multi-functional peripheral executes scanning with the setting content displayed on the display device 41. For example, the digital multi-functional peripheral stores image data of a scanned original in a storage destination designated by the user.

If the user uses the facsimile mode, the user presses the FAX button 43f. If the user presses the FAX button 43f, the digital multi-functional peripheral enters the facsimile mode. If the digital multi-functional peripheral is in the facsimile mode, the display device 41 displays a facsimile setting screen. Immediately after the user presses the FAX button 43f, the display device 41 displays the facsimile setting screen on which default setting in the facsimile mode is reflected. Setting content can be changed in a state in which the facsimile setting screen is displayed. The user can input a telephone number as a destination of facsimile with the ten key 43p in a state in which the facsimile setting screen is displayed. If the user presses the start button 43n, the digital multi-functional peripheral transmits scanned image data to the telephone number displayed on the display device 41 by facsimile.

The setting button 43g is a button for instructing registration of setting values if the user registers the setting values. For example, if the user presses the setting button 43g, the user can perform setting and registration of, for example, set time for auto-clearing setting content (set time for auto-clear), switching of a language displayed on a guide screen or the like, adjustment of brightness of a display screen of a display device, adjustment of gradation correction of a toner image, and adjustment of the position of the toner image with respect to a sheet. If the user presses the set/register button 43g, the user can perform setting and registration including a change of a default value for each of the operation modes such as the copy mode, the scan mode, and the facsimile mode. A setting value such as a default value set by the user after pressing the setting button 43g is stored in a memory 51 in a system controller 5 explained later.

The interrupt button 43h is a button for instructing suspending printing under execution and executing another kind of processing. The counter button 43i is a button for instructing display of a counter. The power saving button 43j is a button for instructing a power saving mode as the operation mode. The power button 43k is a button for instructing turn-on of a power supply. The power button 43k may be a button for instructing shut-down. The reset button 43l is a button for instructing clearing of setting content and return to initial setting. The stop button 43m is a button for instructing the stop of operation. The start button 43n is a button for instructing the start of operation such as copying, scanning, and facsimile. The clear button 43o is a button for instructing correction of a numerical value input with the ten key 43p such as the number of copies. The ten key 43p is a button for inputting a numerical value such as the number of copies.

The setting hold button 43q is a button for instructing maintenance of the present setting content. If the setting hold button 43q is on, the system control unit of the digital multi-functional peripheral maintains the present setting content. For example, in the auto-clear function, if the setting hold button 43q is on, the present setting content cannot be cleared. The user instructs the setting hold button 43q to be turned on or off. For example, the setting hold button 43q is turned on and off every time the user presses the setting hold button 43q. If the setting hold button 43q is on, the display device 41 displays a message for informing that the present setting content is maintained.

Even if the setting hold button 43q is on, if the operation mode selection button (the copy button 43b, the filing box button 43c, the scan button 43d, the print button 43e, or the FAX button 43f) is pressed, the setting hold button 43q is turned off. If the user presses the operation mode selection button while the setting hold button 43q is on, the display device 41 displays a setting screen on which default setting in the operation mode selected by the user is reflected.

The system control unit stores maintenance time in which the setting hold button 43q is maintained on. The setting hold button 43q may be turned off if the maintenance time elapses after the setting hold button 43q is turned on.

The configuration of a control system in the digital multi-functional peripheral configured as above is explained below.

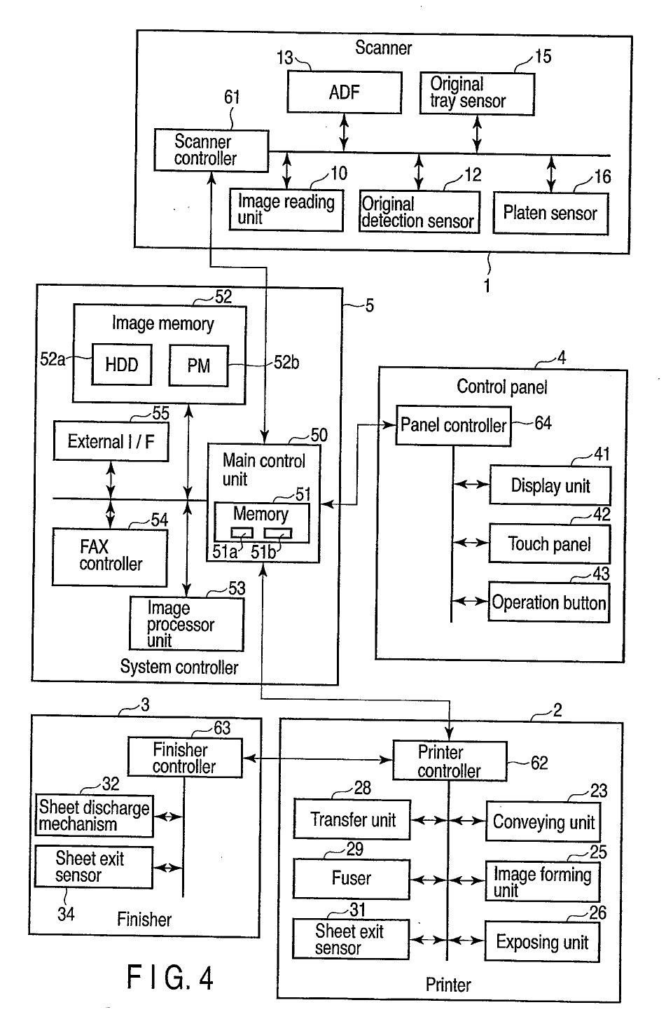

FIG. 4 is a block diagram for explaining a configuration example of the control system in the digital multi-functional peripheral.

The digital multi-functional peripheral includes the system controller 5 configured to control the entire apparatus. The system controller 5 is connected to the scanner 1, the printer 2, the finisher 3, and the control panel 4. The system controller 5 collectively controls the scanner 1, the printer 2, the finisher 3, and the control panel 4.

The system controller 5 includes a main control unit (a processor) 50, an image memory 52, an image processor 53, a FAX controller 54, and an external interface (NW I/F) 55 and the like.

The main control unit 50 controls the entire digital multi-functional peripheral. The main control unit 50 includes, for example, a processor, a RAM, and a ROM. The main control unit 50 is connected to control units of the scanner 1, the printer 2, the control panel 4, and the like. The main control unit 50 outputs operation instructions to the units and acquires various kinds of information from the units through bidirectional communication with the scanner 1, the printer 2, and the control panel 4. For example, the main control unit 50 outputs setting information to the units on the basis of the present valid setting content. The main control unit 50 receives the input of detection signals of sensors and information indicating operation states and the like from the units.

The main control unit 50 includes the memory 51 configured to store setting information and the like. The memory 51 includes a first memory 51a configured to store a first configuration as default setting and a second memory 51b configured to store a second configuration as the present setting content and information such as a flag indicating an operation state. The first memory 51a is a rewritable nonvolatile memory. The first memory 51a stores default settings (first configurations) in the copy mode, the scan mode, and the facsimile mode. The second memory 51b is a working memory configured to store information indicating an operation state, temporary data, or the like.

The image memory 52 includes a hard disk driver (HDD) 52a and a page memory (PM) 52b. The HDD 52a is a large-capacity storage device. For example, the HDD 52a stores plural image data. Setting data other than the image data, a control program, or the like may be stored in the HDD 52a. The page memory 52b is a memory for expanding image data to be processed. The image processor 53 processes the image data. The image processor 53 corrects, compresses, or expands the image data. The FAX controller 54 transmits and receives facsimile data. The external interface 55 is an interface configured to perform data communication with an external apparatus. For example, the external interface 55 receives the input of image data for printing from the external apparatus.

The scanner 1 includes a scanner controller 61. The scanner controller 61 can communicate with the main control unit 50 of the system controller 5. The scanner controller 61 controls the image reading unit 10 and the ADF 13. The processor executes the control program stored in the memory, whereby the scanner controller 61 controls the units in the scanner 1. The scanner controller 61 outputs image data read by the image reading unit 10 to the system controller 5. The scanner controller 61 outputs a detection signal of the original tray sensor 15 and a detection signal of the platen sensor 16 to the main control unit 50.

The printer 2 includes a printer controller 62. The printer controller 62 can communicate with the main control unit 50 of the system controller 5. The printer controller 62 controls the conveying unit 23, the image forming units 25, the exposing unit 26, the transfer unit 28, and the fuser 29 in the printer 2. The processor executes the control program stored in the memory, whereby the printer controller 62 controls the units in the printer 2. The printer controller 62 notifies the main control unit 50 of the system controller 5 of a processing state by the units in the printer 2. The printer controller 62 outputs a detection signal of the sheet sensor 31b to the main control unit 50. The printer controller 62 can communicate with a finisher controller 63 of the finisher 3. The printer controller 62 outputs an operation instruction to the finisher 3 and acquires various kinds of information from the finisher 3.

The finisher 3 includes the finisher controller 63. The finisher controller 63 can communicate with the printer controller 62 of the printer 2. The finisher controller 63 controls the sheet discharge mechanism 32 in the finisher 3. The processor executes the control program stored in the memory, whereby the finisher controller 63 controls the units in the finisher 3. The finisher controller 63 notifies the printer 2 of a processing state in the finisher 3. The finisher controller 63 outputs a detection signal of the sheet exit sensor 34 to the printer controller 62. The printer controller 62 outputs a detection signal of the sheet exit sensor 34 to the main control unit 50.

The control panel 4 includes a panel controller 64. The panel controller 64 can communicate with the main control unit 50 of the system controller 5. The panel controller 64 is connected to the display device 41, the touch panel 42, and the operation buttons 43. The panel controller 64 controls a display screen displayed by the display device 41. The panel controller 64 detects, according to a detection signal from the touch panel 42, a display section of an icon or the like touched by the user. The panel controller 64 outputs information indicating the icon touched by the user to the main control unit 50. The panel controller 64 outputs a signal indicating the operation button 43 pressed by the user to the main control unit 50.

Auto-clear for setting information in the digital multi-functional peripheral is explained below.

First, setting for various kinds of processing (jobs) including scanning of an original is explained. For example, in the digital multi-functional peripheral, as the jobs including scanning of an original, there are copy processing, facsimile processing, scanning processing, and the like. The copy processing is executed in the copy mode instructed by the user with the copy button 43b. The facsimile processing is executed in the facsimile mode instructed by the user with the FAX button 43f. The scan processing is executed in the scan mode instructed by the user with the scan button 43d.

For example, the digital multi-functional peripheral has, in the copy mode, a sort mode for editing and printing images of plural originals. In the sort mode, the digital multi-functional peripheral reads images of plural originals before starting printing. The digital multi-functional peripheral may read images of plural originals of all pages before starting printing. The digital multi-functional peripheral may read images of a part of plural originals before starting printing and read images of the remaining plural originals after starting printing of the read images. If an original is placed on the original glass 11, in order to read document images of all pages, the digital multi-functional peripheral urges, while checking presence or absence of originals of second and subsequent pages, the user to replace the original on the original glass 11 (set an original of the next page).

In copying in a non-sort mode, the digital multi-functional peripheral starts printing without waiting for completion of scanning of an original. In the copying in the non-sort mode, copy time for one original is short compared with that in the copying in the sort mode. In the digital multi-functional peripheral, in order to reduce the copy time for one original, default setting for the copy mode is often the non-sort mode. However, if the preceding user performs copying in the sort mode, unless setting of the sort mode is cleared, the copy mode remains in the sort mode even if the default setting is the non-sort mode. Further, when an original placed on the original glass 11 is read, if the setting of the non-sort mode unintended by the user remains, operation such as check of an original of the next page is necessary against the intension of the user.

If the user opens the ADF 13 and sets an original on the original glass 11, the digital multi-functional peripheral according to this embodiment changes setting content to the default setting (e.g., the non-sort mode). As a result, if the user opens the ADF 13 and sets an original on the original glass 11, the digital multi-functional peripheral can change, without operation by the user, the copy mode to the non-sort mode with short copy time as the default setting.

The digital multi-functional peripheral according to this embodiment has an auto-clear function for clearing the present setting content and changing the setting content to the default setting if non-operation state exceeds a set time or if the operation mode is changed. In the auto-clear function of the digital multi-functional peripheral according to this embodiment, the digital multi-functional peripheral maintains the present setting content if the user operates the control panel 4, if the user sets an original on the ADF 13, or if a sheet as a print result remains on the exit tray 30 or the exit tray 33.

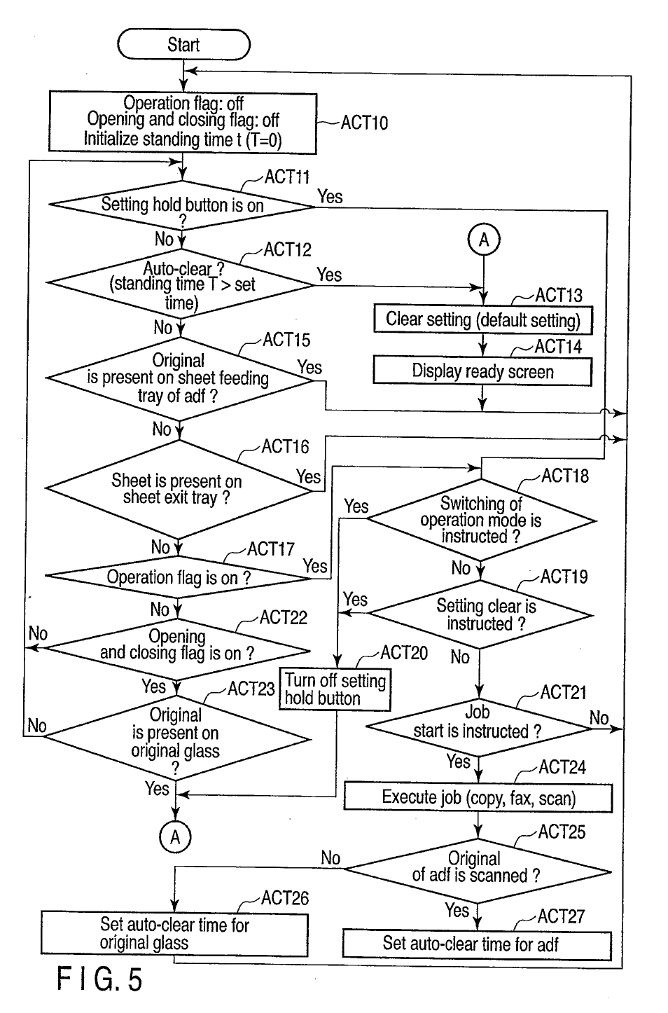

FIG. 5 is a flowchart for explaining the operation of auto-clear in the digital multi-functional peripheral.

When one job ends, the main control unit 50 turns off an operation flag and an opening and closing flag and initializes a standing time (elapsed time) T (T=0) (ACT 10). The memory 51 stores the operation flag, the opening and closing flag, and the standing time T. The main control unit 50 turns on the operation flag if the user touches the touch panel 42 of the control panel 4 or presses the operation button 43 (operates the control panel 4). The main control unit 50 turns on the opening and closing flag if the platen sensor 16 outputs a signal indicating an open state of the ADF 13, i.e., if the user opens the ADF 13. The main control unit 50 may turn on the opening and closing flag if the platen sensor 16 detects opening and closing of the ADF 13. The second memory 51b stores, as the present setting content (the second configuration), setting information input to the control panel 4 by the user.

If the flags and the standing time T are initialized, the main control unit 50 determines whether the setting hold button 43q is on (ACT 11). If the setting hold button 43q is on (YES in ACT 11), the main control unit 50 invalidates the auto-clear function and waits for the input of the start button 43n while maintaining the present setting content. However, even if the setting hold button 43q is on, the main control unit 50 updates, according to setting information input by the user with the control panel 4, the present setting content stored in the second memory 51b.

If the main control unit 50 determines that the setting hold button 43q is not on (NO in ACT 11), the main control unit 50 determines whether the standing time T exceeds set time (e.g., 30 seconds) for auto-clear (ACT 12). The user may be able to set the set time for auto-clear with the control panel 4. If the standing time T exceeds the set time for auto-clear (YES in ACT 12), the main control unit 50 clears the present setting content stored in the second memory 51b (ACT 13). In clearing (resetting) the present setting content, the main control unit 50 rewrites the present setting content stored in the second memory 51b to the default setting in the present operation mode (e.g., the copy mode, the facsimile mode, or the scan mode). After clearing the setting information (changing the setting information to the default setting), the main control unit 50 displays a ready screen showing the setting content of the default setting on the display device 41 of the control panel 4 (ACT 14).

The user may select whether the auto-clear function for clearing setting content according to the set time should be validated or invalidated. If the auto-clear function for clearing setting content according to the set time is invalidated, the main control unit 50 omits the processing in ACT 12.

If the standing time T is within the set time for auto-clear (NO in ACT 12), the main control unit 50 determines whether an original is present on the sheet feeding tray 14 of the ADF 13 (ACT 15). The main control unit 50 determines, according to a detection signal of the original tray sensor 15, whether an original is present on the sheet feeding tray 14. If the main control unit 50 determines that a sheet is present on the sheet feeding tray 14 of the ADF 13 (YES in ACT 15), the main control unit 50 returns to ACT 10 and initializes the standing time T (T=0). If the user places an original on the sheet feeding tray 14 of the ADF 13, the digital multi-functional peripheral according to this embodiment maintains the present setting content stored in the second memory 51b determining that the user desires to process an image of the original with the present setting content.

If the standing time T is within the set time for auto-clear (NO in ACT 12), the main control unit 50 determines whether a sheet is present on the exit tray 30 or the exit tray 33 (ACT 16). The main control unit 50 determines, with the sheet sensor 31b, whether a sheet is present on the exit tray 30. The main control unit 50 determines, with the sheet exit sensor 34, whether a sheet is present on the exit tray 33 of the finisher 3. If the main control unit 50 determines that a sheet is present on the exit tray 30 or the exit tray 33 (YES in ACT 16), the main control unit 50 returns to ACT 10 and initializes the standing time T (T=0). If a sheet remains on the exit tray 30 or the exit tray 33, the digital multi-functional peripheral according to this embodiment maintains the present setting content stored in the second memory 51b determining that the user does not change.

If the standing time T is within the set time for auto-clear (NO in ACT 12), the main control unit 50 monitors whether the digital multi-functional peripheral is not operated by the user (a no-operation state). If there is an input to the operation buttons 43 of the control panel 4 or the touch panel 42, the operation flag is turned on. The main control unit 50 determines, according to whether the operation flag is on, whether the digital multi-functional peripheral is in the no-operation state (ACT 17).

If the operation flag is on (YES in ACT 17), the main control unit 50 determines whether there in an input to the operation mode buttons 43b to 43f, the setting clear (reset) button 43l, or the start button 43n (ACT 18, 19, or 20).

If there is an input to the operation mode buttons 43b to 43f, i.e., if the user presses any one of the operation mode buttons 43b to 43f (YES in ACT 18), the main control unit 50 turns off the setting hold button 43q (ACT 20). After turning off the setting hold button 43q, the main control unit 50 changes the operation mode, changes the present setting content stored in the second memory 51b to the default setting of the operation mode stored in the first memory 51a (ACT 13), and displays a ready screen in the operation mode on the display device 41 (ACT 14). Even if the setting hold button 43q is on, if there is an input to the operation mode buttons 43b to 43f, the main control unit 50 changes the present setting content stored in the second memory 51b to the default setting of the operation mode corresponding to the pressed operation mode button.

If there is an input to the setting clear (reset) button 43l, i.e., if the user presses the setting clear (reset) button 43l for clearing the present setting content (YES in ACT 19), the main control unit 50 turns off the setting hold button 43q (ACT 20). After turning off the setting hold button 43q, the main control unit 50 changes the present setting content stored in the second memory 51b to the default setting of the present operation mode (ACT 13) and displays a ready screen on the display device 41 of the control panel 4 (ACT 14).

If there is an input to the start button 43n, i.e., if the user presses the start button 43n (YES in ACT 21), the main control unit 50 executes a job with the present setting content stored in the second memory 51b (ACT 24).

If there is an input to the operation buttons 43 other than the operation mode buttons 43b to 43f, the setting clear (reset) button 43l, and the start button 43n or the touch panel 42, i.e., if the user operates the control panel 4 (NO in ACT 21), the main control unit 50 returns to ACT 10, turns off the operation flag, and initializes the standing time T (T=0). If there is an input to the control panel 4, the digital multi-functional peripheral according to this embodiment maintains the present setting content stored in the second memory 51b determining that the user is performing work such as setting of a processing mode for a scan image or a change of setting content such as a change of the number of prints. The main control unit 50 stores setting content input to the control panel 4 by the user in the second memory 51b as the present setting content.

If the standing time T is within the set time for auto-clear (NO in ACT 12), the main control unit 50 determines whether the opening and closing flag is on (ACT 22). If the opening and closing flag is on (YES in ACT 22), the main control unit 50 further determines, according to a detection signal of the original detection sensor 12, whether an original is present on the original glass 11 (ACT 23). If an original is present on the original glass 11 (YES in ACT 22), the main control unit 50 changes the present setting content stored in the second memory 51b to the default setting of the present operation mode stored in the first memory 51a (ACT 13) and displays a ready screen on the display device 41 of the control panel 4 (ACT 14).

If the ADF 13 is in the open state (the opening and closing flag is on), the main control unit 50 may clear the present setting content irrespectively of presence or absence of an original on the original glass 11. If the main control unit 50 determines that the opening and closing flag is on, the main control unit 50 may proceed to ACT 13 and clear the present setting content if elapsed time after the ADF 13 is closed exceeds auto-clear time for the document table glass. If the main control unit 50 determines that the opening and closing flag is on, the main control unit 50 may proceed to ACT 13 and clear the present setting content if elapsed time after the immediately preceding processing is started exceeds the auto-clear time for the document table glass.

In ACTS 12, 22, 23, 18, and 19, the main control unit 50 determines whether conditions for clearing the present setting content are satisfied. In the digital multi-functional peripheral according to this embodiment, the main control unit 50 clears the present setting content and changes the present setting content to the default setting if the standing time (the no-operation state) exceeds the set time for auto-clear, if the user opens the ADF 13 and sets an original on the original glass 11, if the user presses the operation mode selection button, or if the user presses the setting clear button. If an original is set on the original glass 11 after the standing time (the no-operation state) exceeds the set time for auto-clear, the main control unit 50 may clear the present setting content and change the present setting content to the default setting.

If the user presses the start button 43n (YES in ACT 21), the main control unit 50 executes a job with the present setting content stored in the second memory 51b (ACT 24). When the job ends, the main control unit 50 determines whether an original conveyed by the ADF 13 is scanned or an original on the original glass 11 is scanned in the executed job (ACT 25).

If the original conveyed by the ADF 13 is scanned (YES in ACT 25), the main control unit 50 sets auto-clear time for the ADF (first time) as set time for auto-clear until the next job (ACT 26). If the original on the original glass 11 is scanned (NO in ACT 25), the main control unit 50 sets auto-clear time for the document table glass (second time) as set time for auto-clear until the next job (ACT 27). Different times can be set as the auto-clear time for the ADF (the first time) and the auto-clear time for the document table glass (the second time). The user can set the first time and the second time. For example, the auto-clear time for the document table glass (the second time) may be set shorter than the auto-clear time for the ADF (the first time).

For example, it is assumed that the immediately preceding user executes a job in the sort mode for continuously scanning and editing a right page and a left page of a book set on the original glass 11. Unless the next user performs operation for clearing setting, even if the user desires to scan an original set on the original glass 11 in the non-sort mode, the present setting content (the sort mode) is not cleared until the set time for auto-clear elapses. In scanning the original on the original glass 11 in the sort mode, the digital multi-functional peripheral requests the user to check presence or absence of the next original. For the user who desires scanning in the non-sort mode, work for checking presence or absence of the next original is troublesome and useless work.

If the auto-clear time for the document table glass is set shorter than the auto-clear time for the ADF, it is easier to auto-clear setting content when the original on the original glass 11 is scanned. For example, whereas the auto-clear time for the ADF is set to 30 seconds, the auto-clear time for the document table glass is set to 5 to 15 seconds. Concerning the auto-clear time for the document table glass, setting content may be auto-cleared in 5 to 10 seconds with reference to time when the ADF 13 is closed or may be auto-cleared in about 15 seconds from the start of a job. By setting the auto-clear time for the document table glass shorter than the auto-clear time for the ADF, it is possible to provide a digital multi-functional peripheral that can perform setting with few mistakes and have high performance.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing apparatus comprising:
a document table on which an original is placed;
a document feeder configured to be capable of opening and closing an upper part of the document table and convey the original;
an opening sensor configured to detect whether the document feeder opens the document table;
an image reading unit configured to generate image data of a first original conveyed by the document feeder or a second original placed on the document table;
an operation unit configured to receive input of information indicating processing content for the image data;
a first memory configured to store a first configuration;
a second memory configured to store a second configuration corresponding to the information input to the operation unit; and
a control unit configured to change the second configuration stored in the second memory to the first configuration, if the opening sensor detects the opening of the document table.

2. The apparatus of claim 1, further comprising a document sensor configured to detect presence of an original on the document table, wherein
the control unit changes the second configuration stored in the second memory to the first configuration, if the opening sensor detects the opening of the document table and the document sensor detects an original on the document table.

3. The apparatus of claim 1, further comprising plural operation mode buttons, wherein
the first memory stores a plural first configuration for each of plural operation modes, and
the control unit changes the second configuration stored in the second memory to the first configuration of the operation mode corresponding to the pressed button, if there is an input to the operation mode buttons.

4. The apparatus of claim 1, further comprising a hold button for instructing maintenance of the second configuration stored in the second memory, wherein
the control unit maintains the second configuration stored in the second memory, if the hold button is on, even if the opening sensor detects the opening of the document table.

5. The apparatus of claim 3, further comprising a hold button for instructing maintaining the second configuration stored in the second memory, wherein
the control unit turns off the hold button if there is an input to the operation mode button.

6. The apparatus of claim 1, further comprising a processing unit configured to process image data read by the image reading unit according to the second configuration stored in the second memory, wherein
the control unit changes the second configuration stored in the second memory to the first configuration, if elapsed time of a state without operation of the operation unit exceeds set time for auto-clear after the processing by the processing unit ends.

7. The apparatus of claim 6, further comprising a sheet feeding sensor configured to detect an original set on the document feeder, wherein
the control unit initializes the elapsed time compared with the set time for auto-clear, if the sheet feeding sensor detects an original after the processing by the processing unit ends.

8. The apparatus of claim 6, wherein
the processing unit is an image forming unit configured to print image data read by the image reading unit on a sheet,
the apparatus further comprises:
a sheet discharge unit configured to discharge the sheet having the image data printed thereon by the image forming unit; and
a sheet discharge sensor configured to detect a sheet on the sheet discharge unit, and
the control unit initializes the elapsed time compared with the set time for auto-clear, if the sheet discharge unit sensor detects a sheet after the processing by the processing unit ends.

9. The apparatus of claim 6, wherein the control unit sets first time as the set time for auto-clear if the image reading unit scans an original on the document feeder in the processing executed by the processing unit and sets second time shorter than the first time as the set time for auto-clear if the image reading unit scans an original on the document table in the processing executed in the processing unit.

10. The apparatus of claim 9, wherein the control unit changes the second configuration stored in the second memory to the first configuration, if elapsed time after the opening sensor detects that the document feeder is closed exceeds the second time.

11. A method for job execution, comprising:
storing a first configuration to be employed in the job execution in a first memory;
storing a second configuration to be employed in the job execution instead of the first configuration, the second configuration corresponding to input of information indicating processing content for the image data in a second memory;
detecting a state of a document feeder capable of opening and closing an upper part of a document table; and
employing the first configuration for the job execution instead of the second configuration if the opening is detected.

12. The method of claim 11, wherein the job execution includes a scanning by an image reading unit configured to generate image data of a first original conveyed by the document feeder and a second original placed on the document table.

13. The method of claim 11, further comprising:
detecting presence of an original on the document table; and
employing the first configuration for the job execution instead of the second configuration if the opening is detected and an original on the document table is detected.

14. The method of claim 11, further comprising:
storing a plural first configuration for each of plural operation modes;
receiving selection of the operation mode; and
employing the first configuration of the selected operation mode for the job execution instead of the second configuration if the selection of the operation mode is received.

15. The method of claim 11, further comprising:
receiving an instruction for holding the second configuration stored in the second memory; and
employing the second configuration stored in the second memory if the instruction for holding the second configuration is received, even if the opening is detected.

16. The method of claim 14, further comprising:
receiving an instruction for holding the second configuration stored in the second memory, wherein
invalidating the instruction for maintaining the second configuration if the selection of the operation mode is received.

17. The method of claim 12, further comprising:
processing image data read by the image reading unit according to the second configuration stored in the second memory; and
employing the first configuration for the job execution instead of the second configuration if elapsed time of a state without operation exceeds set time for auto-clear after the processing ends.

18. The method of claim 17, further comprising:
detecting an original set on the document feeder; and
initializing the elapsed time compared with the set time for auto-clear if an original set on the document feeder is detected after the processing ends.

19. The method of claim 17, further comprising:
as the processing, printing the image data read by the image reading unit on a sheet;
detecting whether a sheet having the image data read by the image reading unit printed thereon remains in a discharged state; and
initializing the elapsed time compared with the set time for auto-clear if it is detected that the sheet remains in the discharged a state.

20. The method of claim 17, further comprising:
setting first time as the set time for auto-clear if the image reading unit scans an original conveyed by the document feeder; and
setting second time shorter than the first time as the set time for auto-clear if the image reading unit scans an original on the document table.
